(19) United States
(12) Patent Application Publication
(10) Pub. No.: US 2024/0421521 A1
(43) Pub. Date: Dec. 19, 2024

(54) CONNECTOR FOR DISPLAY SCREENS

(71) Applicant: FOSHAN RUN'AN PHOTOELECTRIC TECHONOLOGY CO., LTD, Guangdong (CN)

(72) Inventors: Yunzhong LIN, Guangdong (CN); Bin ZHU, Guangdong (CN); Linhui LI, Guangdong (CN)

(73) Assignee: FOSHAN RUN'AN PHOTOELECTRIC TECHONOLOGY CO., LTD, Guangdong (CN)

(21) Appl. No.: 18/490,772

(22) Filed: Oct. 20, 2023

(30) Foreign Application Priority Data
Jun. 17, 2023 (CN) 202321562707.2
Jul. 18, 2023 (CN) 202321901688.1

(51) Int. Cl. H01R 12/79; H01R 12/70; H01R 12/77

(52) U.S. Cl. CPC H01R 12/79; H01R 12/7005; H01R 12/774

(57) ABSTRACT

A connector for display screens is disclosed, comprising a connector body. The connector body is designed with a connecting slot for connecting and fitting. The connecting slot is designed with a conductive bar for electrical connection. The connector body is further designed with an assembly chamber corresponding to the conductive bar. The conductive bar is set in the assembly chamber. The connector body, through the connecting slot, is mounted and fixed to the display screen and the connector, or, through a crimping block, the connector body is fixed to the display screen more stably. Then, the connector body, through the conductive bar, is electrically connected to a golden finger of the display screen.

### CROSS-REFERENCE TO RELATED APPLICATION

This application claims the priority benefit of China application serial no. 202321562707.2, filed on Jun. 17, 2023 and China application serial no. 202321901688.1, filed on Jul. 18, 2023. The entirety of each of the above-mentioned patent applications is hereby incorporated by reference herein and made a part of this specification.

### BACKGROUND

### Technical Field

The present invention relates to the technical field of display screens, particularly relates to a connector for display screens.

### Description of Related Art

A display screen is generally used to display text, images, video, video signals, and other information, such as glass display screens or flexible display screens. Existing display screens generally need to bind FPC (Flexible Printed Circuit, abbreviated as FPC, i.e., flexible circuit board), and then electrically connected to the motherboard through the FPC. The circuit design and wiring process on the FPC is more complex, resulting in higher processing costs for the FPC. Moreover, due to the soft material of the FPC, improper operation by the installer can easily cause damage to the soft circuit on the FPC.

Therefore, further improvements are needed.

### SUMMARY

For the purpose of overcoming the deficiencies of the prior art described above, the present invention proposes a connector for display screens, aiming to solve, at least to a certain extent, one of the above technical problems in the prior art.

The present invention is implemented with a connector for display screens. The connector for display screens comprises a connector body. The connector body is provided with a connecting slot for connecting and fitting. The connecting slot is provided with a conductive bar for electrical connection. The connector body is further provided with an assembly chamber corresponding to the conductive bar. The conductive bar is set in the assembly chamber.

An electrical connecting pin for electrical connection is formed on one end of the conductive bar facing away the connecting slot. A bulging part is formed on another end of the conductive bar facing the connecting slot. The bulging part is bulged upwards in a vertical direction.

The connector body is provided with a plurality of the assembly chambers, and insulating partitions are set between adjacent assembly chambers.

The outer side of the connector body is connected to a protective casing. The protective casing is connected to the upper side as well as the left and right sides of the connector body respectively.

The connector body is provided with a snap part on the left and right sides respectively. The protective casing is provided with snap holes corresponding to the snap part. The snap part is connected and fitted with the snap holes so that the protective casing is fixedly positioned with the connector body.

The bottom of the protective casing is provided with mounting pins extending downwards for mounting and connecting.

The bottom of the connector body is provided with positioning pins for positioning bulges.

The conductive bar is machined and formed from a metal material that can be elastically reset.

The connecting slot is provided with a guiding bevel. The guiding bevel is arranged obliquely from outside to inside in the direction of the connecting slot.

The connecting slot is in an L-shape. The connecting slot has an opening at the top.

The connector further comprises a crimping block and a circuit board. The connector body is fixedly connected to the circuit board through the crimping block.

The crimping block is provided with a locking connection structure. The locking connection structure is connected and fixed to the circuit board to press and fix at least a portion of the connector body to the circuit board.

The lower part of the outer side of the locking connection structure is provided with a locking part. The crimping block can be mounted and fixed to the circuit board through the locking part.

The top surface of the locking part is in the shape of a plane. The outer side to the bottom surface of the locking part is in the shape of an inclined surface. The inclined surface is arranged obliquely from the outside of the top to the inside of the bottom.

The upper middle part of the inner side of the locking connection structure is provided with a supporting part.

The top surface of the supporting part is in the shape of a plane. The side-to-bottom surface of the supporting part has a lead-in bevel. The lead-in bevel is arranged obliquely from top to bottom.

The top surface of the crimping block is provided with a light-transmitting structure for the light to be emitted outwardly.

The circuit board is provided with connecting contacts fitted with the electrical connecting pins of the conductive bars. The number of the connecting contacts is equal to or greater than the number of the electrical connecting pins.

The circuit board is provided with a plug port fitted with the mounting pin. The circuit board is further provided with a positioning hole fitted with the positioning pin.

The circuit board is further provided with a locking port for locking in conjunction with the locking connection structure.

The beneficial effect of the present invention is that the connector body, through the connecting slot, is mounted and fixed to the display screen and the connector, or, through a crimping block, the connector body is fixed to the display screen more stably. Then, the connector body, through the conductive bar, is electrically connected to a golden finger of the display screen. No additional bonding FPC is required on the display screen, which simplifies the production process of the display screen and reduces the production cost of the display screen. Moreover, it avoids damage to the soft circuit on the FPC caused by improper operation of the installer.

Additional aspects and advantages of the present invention will become obvious in the description below or through the practice of the present invention.

### BRIEF DESCRIPTION OF THE DRAWINGS

FIG. 1 is a schematic diagram I of a decomposition of a first embodiment according to embodiments of the present invention.

FIG. 2 is a schematic diagram II of a decomposition of the first embodiment according to embodiments of the present invention.

FIG. 3 is a schematic diagram III of a decomposition of the first embodiment according to embodiments of the present invention.

FIG. 4 is a schematic diagram of a section of the first embodiment according to embodiments of the present invention.

FIG. 5 is an enlarged view at A of the first embodiment according to embodiments of the present invention.

FIG. 6 is a schematic diagram I of a decomposition of a second embodiment according to embodiments of the present invention.

FIG. 7 is a schematic diagram II of a decomposition of the second embodiment according to embodiments of the present invention.

FIG. 8 is a schematic diagram of a section of the second embodiment according to embodiments of the present invention.

FIG. 9 is an enlarged view at A of the second embodiment according to embodiments of the present invention.

FIG. 10 is a schematic diagram of a decomposition of a third embodiment according to embodiments of the present invention.

FIG. 11 is an enlarged view at B of the third embodiment according to embodiments of the present invention.

### DESCRIPTION OF THE EMBODIMENTS

### First Embodiment

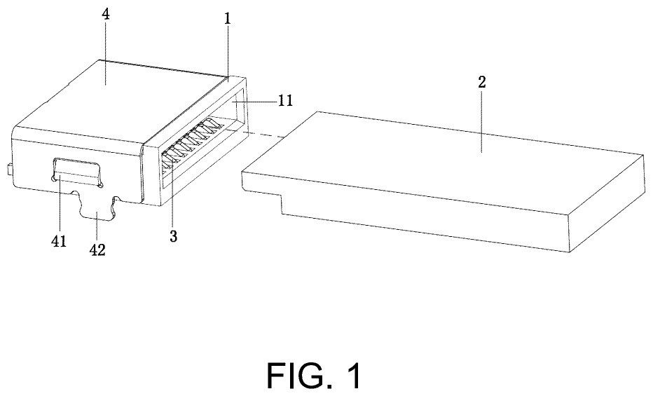

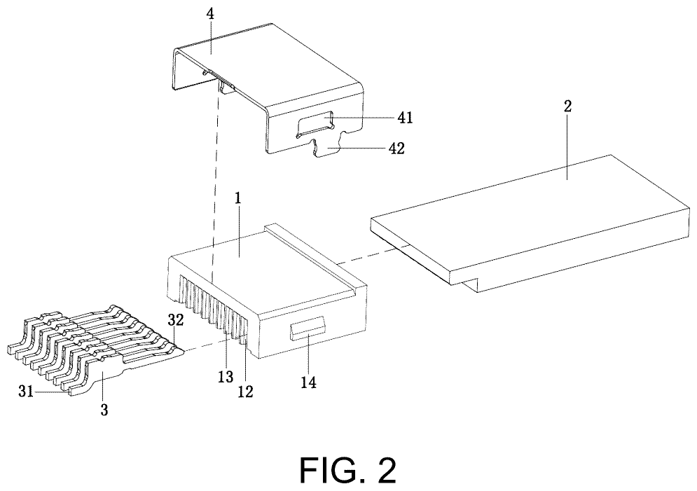

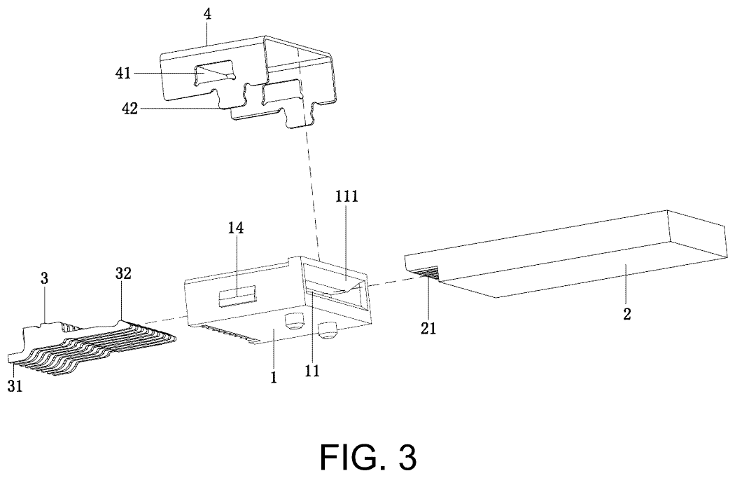

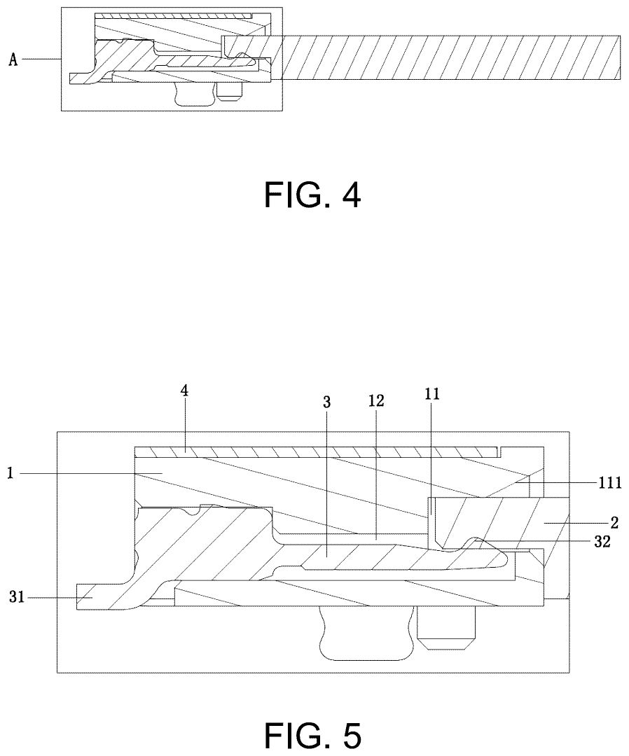

As shown in FIG. 1 to FIG. 5, the present invention proposes a connector for display screens, comprising a connector body 1. The connector body 1 is provided with a connecting slot 11 for connecting and fitting with the display screen 2. The connecting slot 11 is provided with a conductive bar 3 for electrically connecting to the golden finger 21 of the display screen 2. The connector body 1 is provided with an assembly chamber 12 corresponding to the electrically conductive bar 3. The electrically conductive bar 3 is set in the assembly chamber 12. The conductive bar 3 forms an electrical connecting pin 31 backward to one end of the display screen 2. The connector body 1, through the connecting slot 11, is mounted and fixed to the display screen 2 and the connector body 1. Then, through the conductive bar 3, the connector body 1 is electrically connected to the golden finger 21 of the display screen 2. No additional bonding FPC is required on the display screen 2, which simplifies the production process of the display screen 2 and reduces the production cost of the display screen 2. Moreover, it avoids damage to the soft circuit on the FPC caused by improper operation of the installer.

In this embodiment, the display screen 2 may be a glass display screen or a flexible display screen, which is not specifically limited herein and is understood by those skilled in the art.

Further, the conductive bar 3 is provided with a bulging part 32 on the side of the conductive bar 3 against the display screen 2. The bulging part 32 is bulged in a vertical direction toward the golden finger 21 of the display screen 2. The bulging part 32 is connected and fitted with the golden finger 21 of the display screen 2. The bulging part 32 can increase the strength of the connection between the conductive bar 3 and the golden finger 21 of the display screen 2.

Further, the conductive bar 3 is machined and shaped by a metal material that can be elastically reset. The conductive bar 3, after being pressurized by the display screen 2, can be tightly affixed to the golden finger 21 of the display screen 2 under the action of its elastic reset force to ensure that the conductive bar 3 is electrically connected to the golden finger 21.

Further, a guiding bevel 111 is provided at one end of the connecting slot 11 toward the display screen 2. The guiding bevel 111 is arranged obliquely from outside to inside in the direction of the connecting slot 11. The guiding bevel 111 can guide the display screen 2 to enter the connecting slot 11 during the process of mounting and connecting the display screen 2 to the connector body 1.

Further, the connector body 1 is provided with a plurality of assembly chambers 12. Insulating partitions 13 are provided between adjacent assembly chambers 12, which can avoid short-circuiting accidents between different conductive bars 3.

The connector body 1 is connected to a protective casing 4 on the outer side. The protective casing 4 is connected and tightly fitted with the upper side as well as the left and right sides of the connector body 1 respectively. The protective casing 4 can play a protective effect on the connector body 1, as well as improve the overall structural strength of the connector.

Further, the left and right sides of the connector body 1 are provided with snap parts 14. The protective casing 4 is provided with a snap hole 41 corresponding to the snap part 14. The snap part 14 is connected and fitted with the snap hole 41 so that the protective casing 4 is fixed and positioned with the connector body 1, which is convenient to realize the quick disassembly of the connector body 1 and the protective casing 4, and simplifies the connecting structure of the two.

Further, the bottom of the protective casing 4 is provided with a mounting pin 42 that extends downwardly for mounting and connecting to the motherboard, so that the mounting pin 42 of the protective casing 4 is mounted and connected to the motherboard, and the whole connector is quickly mounted and connected to the motherboard.

### Second Embodiment

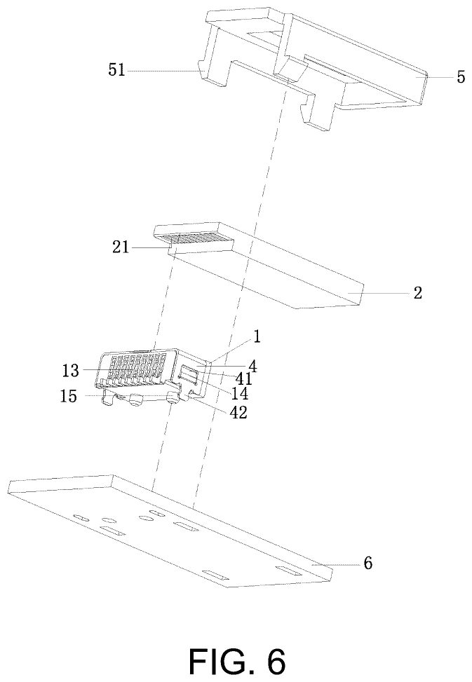

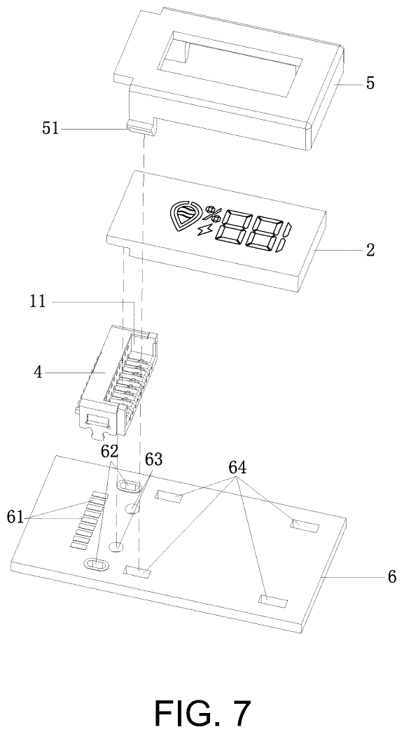

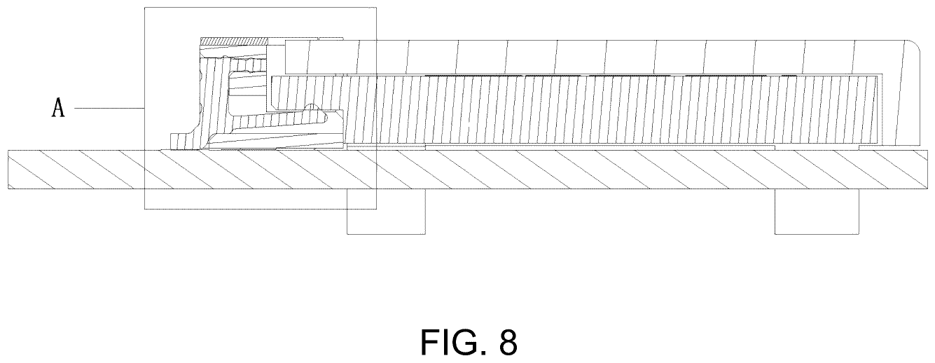

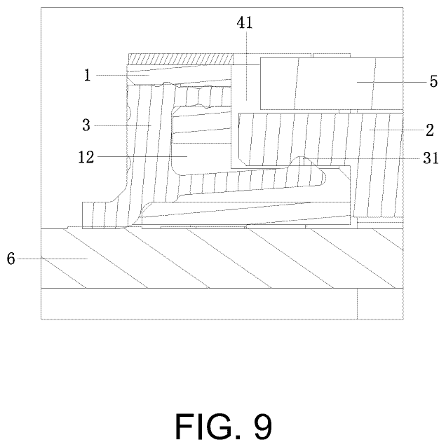

As shown in FIG. 6 to FIG. 9, the present invention proposes a connector for display screens, comprising a crimping block 5 and a connector body 1 for connecting and fitting with the circuit board 6 and the display screen 2. The connector body 1 is provided with a connecting slot 11 for connecting and fitting with the display screen 2. The crimping block 5 is provided with a locking connection structure. The locking connection structure is connected and fixed to the circuit board 6 so that the crimping block 5 can at least partially press and fix the display screen 2 in the connecting slot 11. The connecting slot 11 is provided with a conductive bar 3 for electrically connecting to the golden finger 21 of the display screen 2. The connector body 1 is provided with an assembly chamber 12 corresponding to the conductive bar 3. The conductive bar 3 is set in the assembly chamber 12. The conductive bar 3 forms an electrical connecting pin 31 backward to one end of the display screen 2, for electrically connecting to the circuit board 6. Through the crimping block 5, the display screen 2 is fixed on the connector body 1 more stably. Moreover, the crimping block 5 can also protect the display screen 2 to some extent.

Then, the connector body 1, through the conductive bar 3, is electrically connecting to the golden finger 21 of the display screen 2. No additional bonding FPC is required on the display screen 2, which simplifies the production process of the display screen 2 and reduces the production cost of the display screen 2. Moreover, it avoids damage to the soft circuit on the FPC caused by improper operation of the installer.

In this embodiment, the display screen 2 may be a glass display screen or a flexible display screen, which is not specifically limited herein and is understood by those skilled in the art.

Further, the connecting slot 11 is in an L-shape. The connecting slot 11 has an opening at the top so that the display screen 2 can be directly placed in the connecting slot 11, the mounting and connecting of the display screen 2 and the connecting slot 11 is simpler, and the operation is more convenient.

Further, the lower part of the outer side of the locking connection structure is provided with a locking part 51. The crimping block 5, through the locking part 51, is mounted and fixed on the circuit board 6, so that the crimping block 1 can be mounted and connected to the circuit board 6 more conveniently and quickly, which is less costly compared to the way of screwing or adhesive.

Further, the crimping block 5 is provided with a light-transmitting structure for the light generated by the display screen 2 to be emitted outwardly, preventing the crimping block 5 from affecting the user's normal observation of the display screen 2. In this embodiment, the crimping block 5 is provided with through holes corresponding to the display area of the display screen 2. As an equivalent transformation, the crimping block 5 may also be produced and shaped by a light-transmitting material.

Further, the conductive bar 3 is provided with a bulging part 32 on the side of the conductive bar 3 against the display screen 2. The bulging part 32 is bulged in a vertical direction toward the golden finger 21 of the display screen 2. The bulging part 32 is connected and fitted with the golden finger 21 of the display screen 2. The bulging part 32 can improve the strength of the connection between the conductive bar 3 and the golden finger 21 of the display screen 2.

Further, the conductive bar 3 is machined and shaped by a metal material that can be elastically reset. The conductive bar 3, after being pressurized by the display screen 2, can be tightly affixed to the golden finger 21 of the display screen 2 under the action of its elastic reset force to ensure that the conductive bar 3 is electrically connected to the golden finger 21.

Further, the connector body 1 is provided with a plurality of assembly chambers 12. Insulating partitions 13 are provided between adjacent assembly chambers 12, which can avoid short-circuiting accidents between different conductive bars 3.

Further, the connector body 1 is provided with positioning pins 15 on the side facing the circuit board 6 to improve the precision as well as the stability of the connector when it is mounted on the circuit board 6.

Further, the circuit board 6 is provided with connecting contacts 61 connected and fitted with the electrical connecting pin 31 of the conductive bar 3, wherein the number of the connecting contacts 61 on the circuit board 6 is equal to or greater than the number of the electrical connecting pins 31 of the conductive bars 3, to ensure a full power supply to the conductive bar 3, and a full power supply to the display screen 2. The circuit board 6 is further provided with positioning holes fitted with the positioning pins set at the bottom of the connector body for stability. With the fitting of positioning holes with positioning pins, the connector is positioned firmly on the circuit board. the circuit board is further provided with a plug port 62 connected and fitted with the mounting pin 42 of the protective casing 4. Through the plug port, the protective casing 4 is stabilized and the stability of the connector on the circuit board 6 is strengthened. The circuit board 6 is further provided with a locking port for locking in conjunction with the locking connection structure. Through the locking connection structure on the crimping block 5, the connector and the display screen 2 are pressed and fixed on the circuit board 6 again, which improves the stability and strengthens the precise positioning effect.

### Third Embodiment

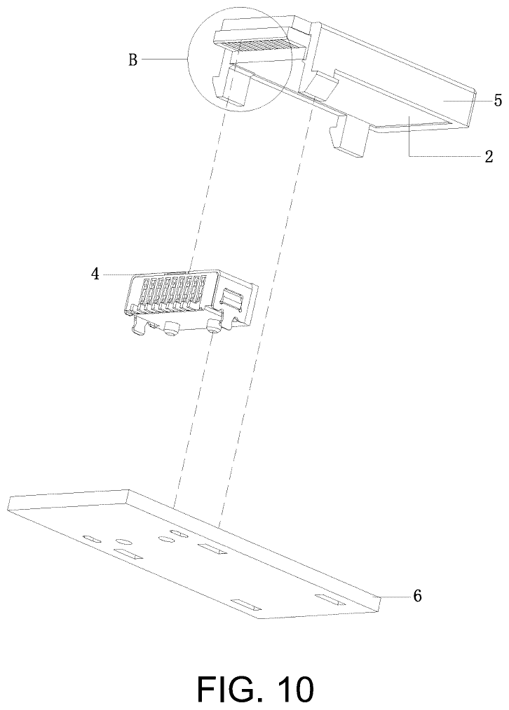

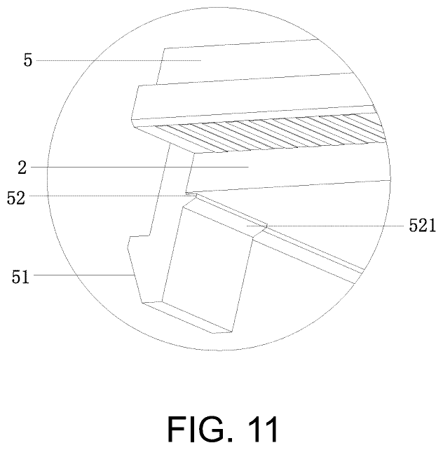

Referring to FIG. 10 and FIG. 11, this embodiment differs from the second embodiment in that the crimping block 5 of the connector of the proposed display screen is provided with a supporting part 52 for supporting the display screen 2, i.e., a worker can first mount the display screen 2 on the crimping block 5 through the supporting part 52 and then connect and fit with the connector body 1 in the form of an integral module, which simplifies the operation of the worker.

Further, the supporting part 52 is provided at a position on the crimping block 5 corresponding to the bottom edge of the display screen 2. The side of the supporting part 52 facing the display screen 2 is in the shape of a plane. The side of the supporting part 52 backward to the display screen 2 has a lead-in bevel 521. The lead-in bevel 521 is arranged obliquely from the outside to the inside in the direction of the display screen 2 so that it is easier to mount and connect the display screen 2 to the crimping block 5.

The above are only preferred embodiments of the present invention and are not intended to limit the present invention. Any modifications, equivalent substitutions, and improvements made within the spirit and principles of the present invention shall be included in the scope of protection of the present invention.

What is claimed is:

1. A connector for display screens, wherein the connector comprises a connector body; the connector body is provided with a connecting slot for connecting and fitting; the connecting slot is provided with at least one conductive bar for electrical connection; the connector body is further provided with at least one assembly chamber corresponding to the at least one conductive bar; and the at least one conductive bar is set in the at least one assembly chamber.

2. The connector for display screens according to claim 1, wherein at least one electrical connecting pin for electrical connection is formed on one end of the at least one conductive bar facing away the connecting slot; a bulging part is formed on another end of the at least one conductive bar facing the connecting slot; and the bulging part is bulged upwards in a vertical direction.

3. The connector for display screens according to claim 2, wherein the at least one assembly chamber comprises a plurality of assembly chambers; and insulating partitions are set between any two adjacent assembly chambers of the plurality of assembly chambers.

4. The connector for display screens according to claim 3, wherein an outer side of the connector body is connected to a protective casing; and the protective casing is connected to an upper side, a left side, and a right side of the connector body.

5. The connector for display screens according to claim 4, wherein the connector body is provided with snap parts on the left side and right side of the connector body; the protective casing is provided with snap holes corresponding to the snap parts; and the snap parts are connected to and fitted with the snap holes so that the protective casing is fixedly positioned with the connector body.

6. The connector for display screens according to claim 5, wherein a bottom of the protective casing is provided with mounting pins extending downwards for mounting and connecting.

7. The connector for display screens according to claim 6, wherein a bottom of the connector body is provided with positioning pins for positioning.

8. The connector for display screens according to claim 7, wherein the at least one conductive bar is machined and formed from an elastically resettable metal material.

9. The connector for display screens according to claim 8, wherein the connecting slot is provided with a guiding bevel; and the guiding bevel is arranged obliquely from outside to inside in the direction of the connecting slot.

10. The connector for display screens according to claim 8, wherein the connecting slot is in an L-shape; and the connecting slot has an opening at a top of the connecting slot.

11. The connector for display screens according to claim 10, wherein the connector further comprises a crimping block and a circuit board; and the connector body is fixed to and connected to the circuit board through the crimping block.

12. The connector for display screens according to claim 11, wherein the crimping block is provided with a locking connection structure; and the locking connection structure is connected to and fixed to the circuit board to press and fix at least a portion of the connector body to the circuit board.

13. The connector for display screens according to claim 12, wherein a lower part of an outer side of the locking connection structure is provided with a locking part; and the crimping block is mounted to and fixed to the circuit board through the locking part.

14. The connector for display screens according to claim 13, wherein a top surface of the locking part is in the shape of a plane; an outer side surface and a bottom surface of the locking part are in the shape of an inclined surface; and the inclined surface is arranged obliquely from an outside of a top of the locking part to an inside of a bottom of the locking part.

15. The connector for display screens according to claim 14, wherein an upper middle part of an inner side of the locking connection structure is provided with a supporting part.

16. The connector for display screens according to claim 15, wherein a top surface of the supporting part is in the shape of a plane; a side-to-bottom surface of the supporting part has a lead-in bevel; and the lead-in bevel is arranged obliquely from top to bottom.

17. The connector for display screens according to claim 16, wherein a top surface of the crimping block is provided with a light-transmitting structure for a light to be emitted outwardly.

18. The connector for display screens according to claim 17, wherein the circuit board is provided with connecting contacts fitted with the at least one electrical connecting pin of the at least one conductive bar; a number of the connecting contacts is equal to or greater than a number of the at least one electrical connecting pin.

19. The connector for display screens according to claim 18, wherein the circuit board is provided with plug ports fitted with the mounting pins; and the circuit board is further provided with positioning holes fitted with the positioning pins.

20. The connector for display screens according to claim 19, wherein the circuit board is further provided with locking ports for locking in conjunction with the locking connection structure.
